(19) United States
(12) Patent Application Publication
(10) Pub. No.: US 2011/0080758 A1
(43) Pub. Date: Apr. 7, 2011

(54) PLANT FOR TRANSMITTING ELECTRIC POWER

(75) Inventor: Gunnar Asplund, Solna (SE)

(73) Assignee: ABB TECHNOLOGY AG, Zurich (CH)

(21) Appl. No.: 12/997,160

(22) PCT Filed: Jun. 10, 2008
(86) PCT No.: PCT/EP08/57208

§ 371 Date: Dec. 27, 2010

(51) Int. Cl. H02J 3/36; H02M 1/32

(52) U.S. Cl. 363/35; 361/54

(57) ABSTRACT

A plant for transmitting electric power comprises a direct voltage network for High Voltage Direct Current and at least one alternating voltage network connected thereto through a station. The station comprises at least one Voltage Source Converter adapted to convert direct voltage into alternating voltage and conversely. In the direct voltage network at least one parallel connection of at least one semiconductor device of turn-off type and a resistor is connected in series with a direct voltage line of the direct voltage network.

### TECHNICAL FIELD OF THE INVENTION AND BACKGROUND ART

The present invention relates to a plant for transmitting electric power comprising a direct voltage network for High Voltage Direct Current and at least one alternating voltage network connected thereto through a station, in which the station is configured to perform transmitting of electric power between the direct voltage network and the alternating voltage network and comprises at least one Voltage Source Converter adapted to convert direct voltage into alternating voltage and conversely.

High voltage means in this context typically a voltage of 1 kV to 1200 kV, and mostly a voltage of 50 kV to 800 kV.

Currents flowing in said direct voltage network may typically be 100 A to 7 kA.

The Voltage Source Converters used in such a plant may be of any conceivable type, such as two-level, three-level, multi-level Voltage Source Converters and also of the so-called Modular Multi Level Converter-type of M2LC.

Such a Voltage Source Converter in such a plant includes a semiconductor device of turn-off type in parallel with a diode that is connected in the reverse direction, i.e. in anti-parallel with the semiconductor device. This makes it very easy to control faults on the alternating voltage side, since said semiconductor device may be turned off and thereby prevent current to flow in the forward direction thereof. In the backward direction thereof said diode will prevent the current from flowing through the converter.

However, faults on the direct voltage side cannot be handled in the same way. The diode will get voltage in the forward direction and the only thing that limits the current are outside impedances, such as the alternating voltage network impedance, a transformer impedance and a phase reactor connected to the alternating voltage side of the converter. Also reactors on the direct voltage side of the converter will assist to keep the current level down initially after a fault has occurred.

This together means that with a certain current handling capability of the diodes of said Voltage Source Converter a certain total reactance in said transformer and phase reactor is needed in order to keep a short-circuit current flowing in the direct voltage network upon occurrence of said fault below the limit of the current the diodes may take. This may require a reactance in transformer and phase reactor which will give limitations in active and especially in reactive power transmitted by the plant.

EP 0 867 998 A1 describes a plant of the type defined in the introduction addressing this problem by arranging at least a parallel connection of at least one semiconductor device of turn-off type and a surge diverter in the direct voltage network of the plant. By having such a parallel connection in the direct voltage network the current through the direct voltage network may very rapidly be limited, since such a semiconductor device may be turned off rapidly, should there be a need thereof. When the surge diverter is suitably dimensioned, i.e. the voltage level at which it becomes conducting, the current in the direct voltage network may also be broken by turning the semiconductor device off. The electric energy absorbed by the parallel connection will substantially as a whole be absorbed by the surge diverter and the semiconductor device will be protected against overcurrents.

### SUMMARY OF THE INVENTION

The object of the present invention is to provide a plant of the type defined in the introduction being improved in at least some aspect with respect to such plants already known.

This object is according to the invention obtained by providing such a plant in which at least one parallel connection of at least one semiconductor device of turn-off type and a resistor is connected in series with a direct voltage line of the direct voltage network.

By connecting such a resistor in parallel with said semiconductor device in said parallel connection a very high energy absorption may be achieved at a low cost. This totally new approach to connect a resistor in parallel with a so-called dc switch resulting in these advantages has previously not been considered due to the very high losses normally resulting in the resistor. However, the present inventor has realized that this is possible for a plant of this type, since the resistor has upon occurrence of said fault only to conduct during a very short period of time. The resistor may function as a type of current limiter and is considerably less costly than a surge diverter. This means that the present invention enables a saving of costs would it be decided to replace the surge diverter in the parallel connection, according to said plant already known, by a resistor.

According to an embodiment of the invention the resistance of the resistor at room temperature is 10 Ω-100 Ω, preferably 20 Ω-50 Ω. These are suitable ranges for the resistance for a plant of this type, since the resistor then provides a reverse voltage of the same order of magnitude as the direct voltage of the converter bridge when the latter is short-circuited.

According to another embodiment of the invention the plant also comprises a surge diverter connected in parallel with said semi-conductor device and resistor of said parallel connection. Thus, to have a surge diverter connected in parallel with a resistor the protection level of said parallel connection will be raised, since the surge diverter will ensure that the voltage across the semi-conductor device will not be too high at the same time as the major part of the electric energy to be absorbed is absorbed by the less costly resistor. A less costly surge diverter may by this also be selected.

According to another embodiment of the invention the voltage rating of said surge diverter is lower than the voltage blocking capacity of said at least one semiconductor device of said parallel connection, which ensures that the voltage across said semiconductor device may not be harmful thereto.

According to another embodiment of the invention the plant comprises an apparatus configured to turn said at least one semiconductor device of said parallel connection off when the current therethrough exceeds a predetermined level. At least a current limitation in the direct voltage network takes place by this.

According to another embodiment of the invention said apparatus is configured, when the current in the direct voltage network exceeds a predetermined level, to start to alternatingly turn said at least one semiconductor device of said parallel connection off and on with a frequency adapted for adjusting the current in the direct voltage network to not exceed a maximum level. By such an alternating turning off and on of said at least one semiconductor device the current in the direct voltage network may be adjusted to a desired level and accordingly the current may be restricted in a desired way. The intensity of the current will depend upon the relationship between the length of the turn-off and the turn-on times of said at least one semiconductor device of the parallel connection.

According to another embodiment of the invention said apparatus is configured to carry out turning on and turning off of said at least one semiconductor device with a frequency in the region of the frequency by which semiconductor devices of said Voltage Source Converter are turned on and turned off. It is advantageous to carry out said alternating turning on and off of said at least one semiconductor device for obtaining an appropriate current limiting effect with such a frequency that is located at substantially the same level as the frequency through which the semiconductor devices of the current valves of the Voltage Source Converter are controlled, since this means that the apparatus may follow the Voltage Source Converter and may obtain an appropriate restriction of the currents through the direct voltage network.

According to another embodiment of the invention said at least one semiconductor device of turn-off type is an IGBT (Insulated Gate Bipolar Transistor), an IGCT (Integrated Gate Commutated Thyristor) or a GTO (Gate Turn-Off Thyristor). These are semi-conductor devices suitable to be used in said parallel connection in a plant according to the invention.

According to another embodiment of the invention the plant is configured to have a direct voltage across poles of said direct voltage network being 1 kV to 1200 kV, 10 kV to 1200 kV or 100 kV to 1200 kV.

According to another embodiment of the invention said at least one Voltage Source Converter of said station is of the type having at least one phase leg, which connects to opposite poles of a direct voltage side of the converter and comprises a series connection of switching cells, each said switching cell having on one hand at least two semiconductor assemblies having each a semiconductor device of turn-off type and a free-wheeling diode connected in anti-parallel therewith and on the other at least one energy storing capacitor, a mid point of said series connection forming a phase output being configured to be connected to an alternating voltage side of the converter, each said switching cell being configured to obtain two switching states by control of said semiconductor devices of each switching cell, namely a first switching state and a second switching state, in which the voltage across said at least one energy storing capacitor and a zero voltage, respectively, is applied across the terminals of the switching cell, for obtaining a determined alternating voltage on said phase output. Such a Voltage Source Converter is associated with low losses, so that in such a plant low operation losses may be combined with low costs of said parallel connection.

Further advantages as well as advantageous features of the invention will appear from the following description.

### BRIEF DESCRIPTION OF THE DRAWING

With reference to the appended drawing, below follows a description of embodiments of the invention cited as examples.

In the drawing:

FIG. 1 is a very schematic diagram of a part of a plant according to a first embodiment of the invention, and

FIG. 2 is a diagram similar to FIG. 1 of a plant according to a second embodiment of the invention.

### DETAILED DESCRIPTION OF EMBODIMENTS OF THE INVENTION

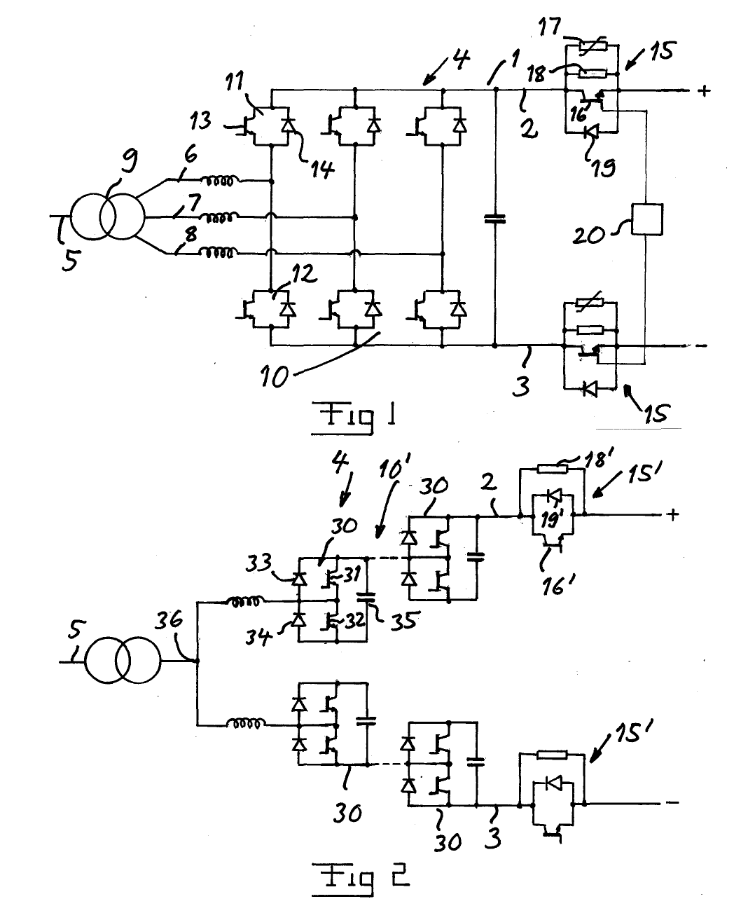

The structure of a plant for transmitting electric power according to a first embodiment of the invention is very schematically and simplified illustrated in FIG. 1, in which mainly only the different components having directly something to do with the function according to the invention have been shown in the drawing so as to facilitate the comprehension of the invention. The plant comprises a direct voltage network 1 for High Voltage Direct Current (HVDC) having two pole conductors or lines 2, 3 and an alternating voltage network 5 connected to the direct voltage network through a station 4, said alternating voltage network having in the present case three phases 6, 7, 8. It is shown how the station 4 is connected to the alternating voltage network through a transformer 9, but it is also conceivable to connect the converter directly to the alternating voltage network without any such transformer. The station 4 is designed to perform transmittance of electric power between the direct voltage network 1 and the alternating voltage network 5, in which the power may be fed in from the alternating voltage network to the direct voltage network or fed out from the direct voltage network to the alternating voltage network. Thus, the alternating voltage network may have generators of electric power or only be connected to consumers thereof. The station comprises at least one Voltage Source Converter 10 configured to convert direct voltage into alternating voltage and conversely. However, it is completely possible that the station comprises a plurality of such converters. The converter comprises in a conventional way one phase leg for each phase with two so-called current valves 11, 12, which consist of branches of breakers 13 in the form of semiconductor devices of turn-off type, preferably in the form of IGBTs, connected in series and diodes 14 connected in anti-parallel therewith. A high number of IGBTs may then be connected in series in one single valve so as to be turned on and turned off simultaneously so as to function as one single breaker, wherethrough the voltage across the valve is distributed among the different breakers connected in series. The control of the breakers takes place in a conventional way through Pulse Width Modulation (PWM).

The plant comprises a parallel connection 15 of a semiconductor device 16 of turn-off type, which may be of any type having an ability of breaking the current therethrough, such as an IGBT, GTO, IGCT etc, a surge diverter 17 and a resistor 18 connected in the direct voltage network. A rectifier diode 19 is also connected in anti-parallel with the semiconductor device 16. Each pole conductor 2, 3 of the direct voltage network is provided with such a parallel connection 15.

The surge diverter 17 is of a conventional type, such as a zinc oxide diverter, and it conducts normally a very low current, but when the voltage thereacross exceeds a certain level it will take a strongly increased current.

The resistor has typically a resistance at room temperature in the range of 10 Ω-100 Ω, preferably 20 Ω-50 Ω.

The plant also comprises an apparatus 20 configured to turn the semiconductor device 16 off, when the current therethrough exceeds a predetermined level. More exactly, the semiconductor device 16 will in normal operation be turned on, but when any fault occurs in the plant, such as a ground fault in the direct voltage network, and the voltage drop over the direct voltage network is great with a risk of high currents therethrough, the apparatus 20 begins alternatingly to turn the semiconductor device 16 on and off with a comparatively high frequency (in the range of some kHz), so that the current through the direct voltage network will be commutated between the semiconductor device 16 and the surge diverter 17 and the resistor 18 and by that a current limiting effect will be obtained. The resistor may then be designed to absorb the major part of the electric energy created by said fault current in said parallel connection 15.

The intensity of the resulting current will depend upon the relationship between the lengths of the turn-off times and turn-on times of the semiconductor device 16.

A plant according to a second embodiment of the invention is illustrated in FIG. 2. This differs from the plant shown in FIG. 1 by the fact that the Voltage Source Converter is here a so-called M2LC-converter, in which each phase leg thereof comprises a series connection of switching cells 30, which each has on one hand at least two semiconductor assemblies having each a semiconductor device 31, 32 of turn-off type and a free-wheeling diode 33, 34 connected in parallel therewith and on the other at least one energy storing capacitor 35. A mid point 36 of said series connection forming a phase output is configured to be connected to an alternating voltage side of the converter. Each said switching cell is configured to obtain two switching states by control of said semiconductor devices 31, 32 of the switching cell, namely a first switching state and a second switching state, in which the voltage across said at least one energy storing capacitor 35 and a zero voltage, respectively, is applied across the terminals of the switching cell, for obtaining a determined alternating voltage on said phase output. In a Voltage Source Converter used in a plant according to the invention handling high voltages a comparatively high number of such switching cells are to be connected in series or a high number of semiconductor devices, i.e. said semiconductor assemblies, are to be connected in series in each said switching cell, since the voltage of the direct voltage side of the converter is determined by the voltages across said energy storing capacitors of the switching cells. A Voltage Source Converter of this type is particularly interesting when the number of the switching cells in said phase leg is comparatively high, as will be the case for a plant of this type. A high number of such switching cells connected in series means that it will be possible to control these switching cells to change between said first and second switching state and by that already at said phase output obtain an alternating voltage being very close to a sinusoidal voltage. This may be obtained already by means of substantially lower switching frequencies than used for a Voltage Source Converter of the type shown in FIG. 1, such as in the order of 100 Hz-500 Hz. This makes it possible to obtain substantially lower losses and also considerably reduces problems of filtering and harmonic currents and radio interference, so that equipment therefor may be less costly.

The converter shown in FIG. 2 may of course have more than one phase leg, but only one is shown for simplifying reasons.

The plant according to FIG. 2 has in each pole conductor of the direct voltage network a parallel connection 15′ corresponding to said parallel connection in the embodiment shown in FIG. 1 except for the absence of a surge diverter. It has turned out that it is possible to manage without a surge diverter by an appropriate dimensioning of said resistor 18′, since the period of time during which this will conduct will be very short. Thus, the resistor may enable turning off of the semiconductor device 16′ as described above while absorbing a high amount of electric energy in said short period of time.

The invention is of course not in any way restricted to the embodiments thereof described above, but many possibilities to modifications thereof will be apparent to a person with ordinary skill in the art without departing from the scope of the invention as defined in the appended claims.

It is well possible that the plant comprises a plurality of said parallel connections connected in the direct voltage network, through which it will be possible to limit the currents through the direct voltage network differently strong by a different number of semiconductor devices.

It is also possible to have two semiconductor devices in the parallel connection and to connect them in series with oppositely directed conducting directions, and to have a separate rectifier diode in anti-parallel with each of the semiconductor devices, for taking care of fault currents in a plant of such a type that the currents through the direct voltage network may assume two possible directions.

1.-10. (canceled)

11. A plant for transmitting electric power comprising a direct voltage network for High Voltage Direct Current and at least one alternating voltage network connected thereto through a station, in which the station is configured to perform transmitting of electric power between the direct voltage network and the alternating voltage network and comprises at least one Voltage Source Converter connected to a first and a second direct voltage line of the direct voltage network and adapted to convert direct voltage into alternating voltage and conversely, each direct voltage line connected to said Voltage Source Converter being further connected in series with a corresponding parallel element combination for limiting a fault current in case of a dc-side short circuit, each parallel element combination comprising at least one semiconductor device of turn-off type, said plant also comprising an apparatus adapted to turn said at least one semiconductor device of said parallel element combinations off when the current therethrough exceeds a predetermined level and, when the current in the direct voltage network exceeds a predetermined level, to start to alternatingly turn said at least one semiconductor device of said parallel element combinations off and on with a frequency in the kHZ range adapted for adjusting the current in the direct voltage network to not exceed a maximum level, wherein each parallel element combination comprises a resistor in parallel with the semiconductor device.

12. The plant according to claim 11, wherein the resistance of the resistor at room temperature is 10 Ω-100 Ω.

13. The plant according to claim 11, wherein the element combination comprises a surge diverter connected in parallel with said semiconductor device and resistor.

14. The plant according to claim 13, wherein the voltage rating of said surge diverter is lower than the voltage blocking capacity of said at least one semiconductor device of said parallel element combination.

15. The plant according to claim 11, wherein said apparatus is adapted to carry out turning on and turning off of said at least one semiconductor device with a frequency in the region of the frequency by which semiconductor devices of said Voltage Source Converter are turned on and turned off.

16. The plant according to claim 11, wherein at least one semiconductor device of turn-off type is an IGBT (Insulated Gate Bipolar Transistor), an IGCT (Integrated Gate Commutated Thyristor) or a GTO (Gate Turn-Off Thyristor).

17. The plant according to claim 11, wherein it is configured to have a direct voltage across poles of said direct voltage network being 1 kV to 1200 kV, 10 kV to 1200 kV or 100 kV to 1200 kV.

18. The plant according to claim 11, wherein at least one Voltage Source Converter of said station is of the type having at least one phase leg, which connects to opposite poles of a direct voltage side of the converter and comprises a series connection of switching cells, each said switching cell having on one hand at least two semiconductor assemblies having each a semiconductor device of turn-off type and a free-wheeling diode connected in anti-parallel therewith and on the other at least one energy storing capacitor, a mid point of said series connection forming a phase output being configured to be connected to an alternating voltage side of the converter, each said switching cell being configured to obtain two switching states by control of said semiconductor devices of each switching cell, namely a first switching state and a second switching state, in which the voltage across said at least one energy storing capacitor and a zero voltage, respectively, is applied across the terminals of the switching cell, for obtaining a determined alternating voltage on said phase output.

19. The plant according to claim 12, wherein the element combination comprises a surge diverter connected in parallel with said semiconductor device and resistor.

20. The plant according to claim 12, wherein said apparatus is adapted to carry out turning on and turning off of said at least one semiconductor device with a frequency in the region of the frequency by which semiconductor devices of said Voltage Source Converter are turned on and turned off.

21. The plant according to claim 13, wherein said apparatus is adapted to carry out turning on and turning off of said at least one semiconductor device with a frequency in the region of the frequency by which semiconductor devices of said Voltage Source Converter are turned on and turned off.

22. The plant according to claim 14, wherein said apparatus is adapted to carry out turning on and turning off of said at least one semiconductor device with a frequency in the region of the frequency by which semiconductor devices of said Voltage Source Converter are turned on and turned off.

23. The plant according to claim 12, wherein at least one semiconductor device of turn-off type is an IGBT (Insulated Gate Bipolar Transistor), an IGCT (Integrated Gate Commutated Thyristor) or a GTO (Gate Turn-Off Thyristor).

24. The plant according to clam 13, wherein at least one semiconductor device of turn-off type is an IGBT (Insulated Gate Bipolar Transistor), an IGCT (Integrated Gate Commutated Thyristor) or a GTO (Gate Turn-Off Thyristor).

25. The plant according to clam 14, wherein at least one semiconductor device of turn-off type is an IGBT (Insulated Gate Bipolar Transistor), an IGCT (Integrated Gate Commutated Thyristor) or a GTO (Gate Turn-Off Thyristor).

26. The plant according to clam 15, wherein at least one semiconductor device of turn-off type is an IGBT (Insulated Gate Bipolar Transistor), an IGCT (Integrated Gate Commutated Thyristor) or a GTO (Gate Turn-Off Thyristor).

27. The plant according to claim 12, wherein it is configured to have a direct voltage across poles of said direct voltage network being 1 kV to 1200 kV, 10 kV to 1200 kV or 100 kV to 1200 kV.

28. The plant according to claim 13, wherein it is configured to have a direct voltage across poles of said direct voltage network being 1 kV to 1200 kV, 10 kV to 1200 kV or 100 kV to 1200 kV.

29. The plant according to claim 14, wherein it is configured to have a direct voltage across poles of said direct voltage network being 1 kV to 1200 kV, 10 kV to 1200 kV or 100 kV to 1200 kV.

30. The plant according to claim 11, wherein the resistance of the resistor at room temperature is 20 Ω-50 Ω.
